(19) United States
(12) Patent Application Publication
(10) Pub. No.: US 2007/0095279 A1
(43) Pub. Date: May 3, 2007

(54) Spray enclosure

(76) Inventor: Gary D. Langeman, Ruthven (CA)

Correspondence Address: NIELDS & LEMACK, 176 EAST MAIN STREET, SUITE 7, WESTBORO, MA, 01581, US

(21) Appl. No.: 11/260,592

(22) Filed: Oct. 27, 2005

(51) Int. Cl. B05B 15/12

(52) U.S. Cl. 118/326; 454/50

(57) ABSTRACT

A spray enclosure is provided for plural component coating application. The enclosure has a framework of four panel walls and a ceiling with a protective film cladding to altogether enclose a protected workspace. An air inlet in one wall uses a louvered grille with double-deflection louvers to deflect incoming air to the workspace. An air filter, fan and exhaust assembly is provided on an opposite wall for filtering and drawing air through the protected workspace to an exhaust. The spray enclosure is adapted for efficient laminar air flow through the protected workspace. The spray enclosure may be sold in parts as a kit.

### FIELD OF THE INVENTION

The invention relates to plural component coating application, and more particularly to a workspace for plural component coating application.

### BACKGROUND OF THE INVENTION

Plural component coatings are commonly applied by spraying. However, the spray process can result in undesirable vapors and particulate in the air, which may be hazardous to the operator applying the coating. In the case of polyurethane coating, isocyanate vapors can be toxic if inhaled. Fresh air ventilators are commonly used by operators while spraying. However, the air in the shop where the coating is being sprayed may still contain vapors for some period after the spraying is finished. At this point, once the operator has removed the fresh air ventilator, he/she may unknowingly be exposed to lingering vapors.

### SUMMARY OF THE INVENTION

It would be desirable to develop a simple means for containing such vapors within a work area in a shop and filtering the air in the work area to exhaust it away from the operator and the rest of the shop. A simple enclosure should have air flow patterns that keep air moving through the entire work area and toward the filter/exhaust. Preferably, the system should keep a lively flow of air through the enclosure without having to draw on massive volumes of make-up air (which must be heated, for example, in winter, or cooled, in summer, for operator comfort and optimum coating performance). However, reducing air volume brought into the enclosure will naturally have an effect on air velocity through the enclosure. Stagnant parts of the enclosure may not be effectively purged of pollutants. Accordingly, it is an object of the present invention to reduce air volume while maintaining lively circulation of air in the enclosure. To prevent “dead spots” in the air flow through the enclosure, the air must be controlled in its path, rather than being left to flow merely according to the pull pattern of the fan. As described herein, air can be specifically deflected into problem areas such as corners to correct the problem of “dead spots”.

Having regard to these objects, a spray enclosure is provided for plural component coating application. The enclosure, made up of four walls and a ceiling, uses framed panels cladded with protective film. The cladded walls make up a protected workspace. One wall (preferably, a front wall) will have an opening for entry and exit of an operator and the workpiece to be coated. One of the walls (preferably, again, the front wall) will have an air inlet portion that is covered by one or more louvered grilles. The grilles are special in that they contain double-deflection louvers. That is, the louvers are manipulable in two directions (in two axes) to deflect incoming air to the protected workspace. On an opposite wall, the enclosure has an air filter-fan-exhaust assembly for filtering and drawing air through the protected workspace to an exhaust. Importantly, the spray enclosure is designed to make the most efficient use of air by engineering the laminar air flow through the workspace.

The air inlet portion preferably extends across the width of the first wall. The grille preferably has two sets of louvers—one set running in a horizontal orientation (relative to the orientation of the wall), and a second set running in a vertical orientation (relative to the wall). The louvers are movable (either as a set or individually) between open and closed positions. The sets of louvers do not interfere with each other. As one potential option, the louvers of the grille may be pre-set by the enclosure fabricator to an orientation that will direct air into otherwise dead spots in the protected workspace.

The workpiece to be coated is preferably a vehicle surface (such as a truck bed). In this case, the opening in the wall should be sized for entry and exit of a vehicle. Surfaces on the vehicle may be sprayed while attached to the vehicle (with non-sprayed parts masked beforehand), or individual parts (such as a rear gate on a pickup truck or a running board) may be sprayed and then installed or re-installed on the vehicle.

Preferably, the spray enclosure is adapted for plural component spray by an operator. One example of plural component spray is polyurethane coating. This is particularly suitable for the present enclosure as the spray contains isocyanate vapor, which must be filtered and exhausted from the chamber to provide a safe environment for the spray gun operator. Although operators are required to wear fresh air masks while spraying, the surrounding air may still be hazardous when the spraying is completed and the operator removes his mask.

The spray enclosure may be sold as a kit for assembly on site.

### BRIEF DESCRIPTION OF THE DRAWINGS

FIG. 1 shows a side view diagram of the spray enclosure in use by an operator, including air flow through inlet 120.

FIG. 2 shows a top view diagram of a finished coated surface 150 in the enclosure.

FIG. 3 shows a front view of the enclosure showing the fan-filter-exhaust assembly.

FIG. 4 shows a perspective (front) view of the enclosure showing front 200 and (optional) side 210 entrances. The view also shows detail of the grilles 220 at inlet 120.

FIG. 5 shows a perspective (back) view of the enclosure showing rear view of the fan-filter-exhaust assembly.

FIG. 6 shows detail of grille 220 with horizontal and vertical louvers.

### DETAILED DESCRIPTION OF THE DRAWINGS

As shown in the drawings, a spray enclosure 100 is provided. Preferably, the enclosure 100 is a simple framed structure which can be built on site, such as within an existing shop 110 (such as a autobody shop or a paint shop).

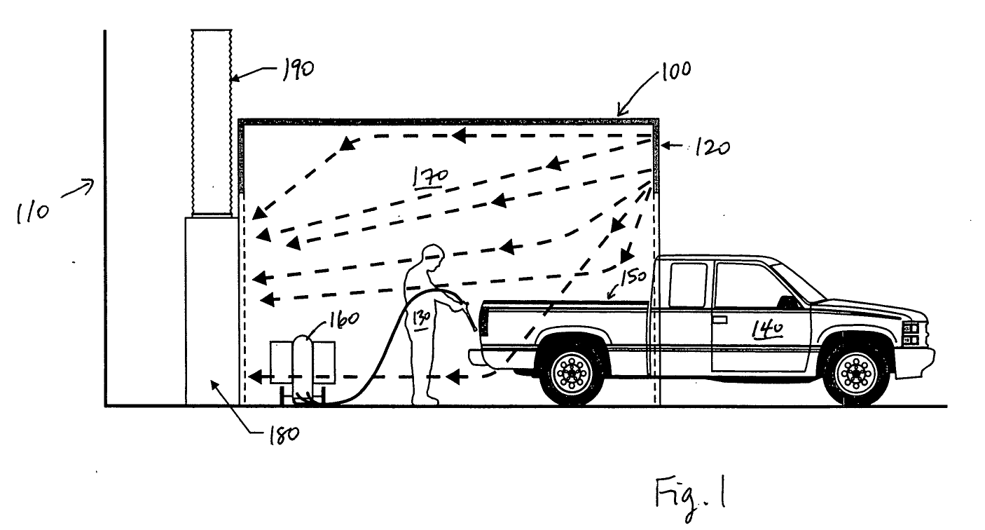

FIG. 1 illustrates a sample spray enclosure 100 in use for plural component spray of a spray-on truck bed liner. The enclosure 100, in this case, is adapted for drive-in access for a vehicle 140 through a front opening (other types of workpieces and coating applications are also possible). The operator 130 using a plural component spray apparatus 160 applies the coating to the surface to be coated 150 (in this case, a truck bed). As shown in FIG. 1, the air flow moves evenly from the air inlet portion 120 through the entire workspace 170 and is drawn to filter-fan-exhaust assembly 180 where “used” air can be exhausted via duct 190. (While not shown in the drawing, the exhaust duct would in most cases remove the air entirely from the shop directly to the outside, or it may pass through additional filters or air scrubbers—not shown.)

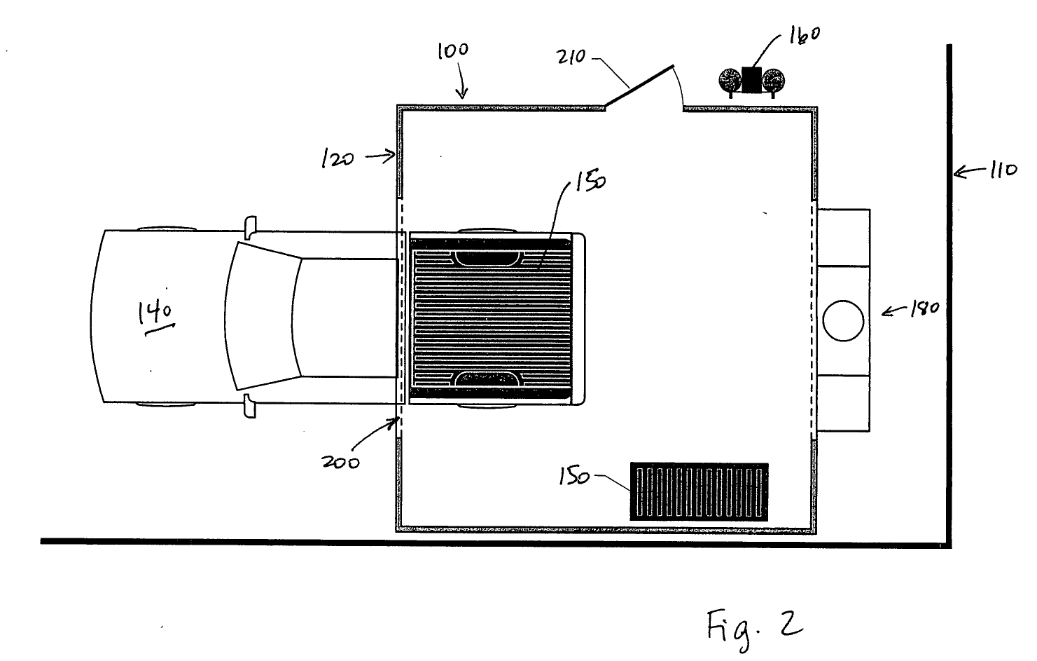

FIG. 2 illustrates finished coated surfaces 150 (in this case, a truck bed liner and separate gate for truck bed) within the enclosure. As shown in this Figure and the previous one, the vehicle surface to be coated may be parked (or otherwise positioned) within the protected workspace while the parts not intended to be coated may be parked outside the enclosure. Masking material (not shown) may be used to further discriminate between areas to be coated and those to remain uncoated. Door 200 may also be “sealed” around the vehicle to keep air and pollutants within the workspace. The enclosure has an optional side entrance 210 for ease of operator entry/exit and for moving the spray equipment 160 and materials into and out of the workspace.

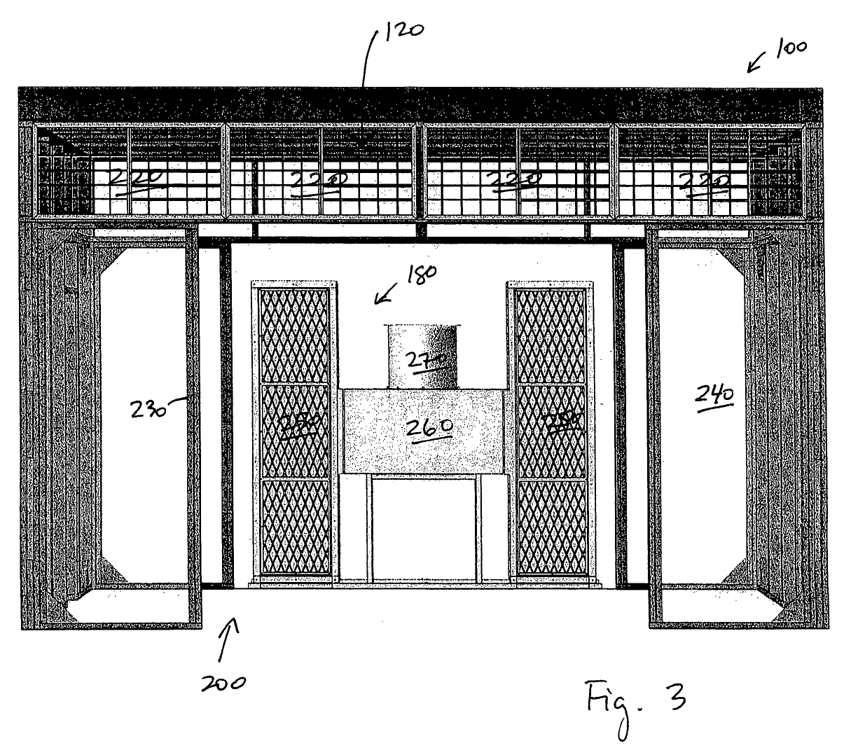

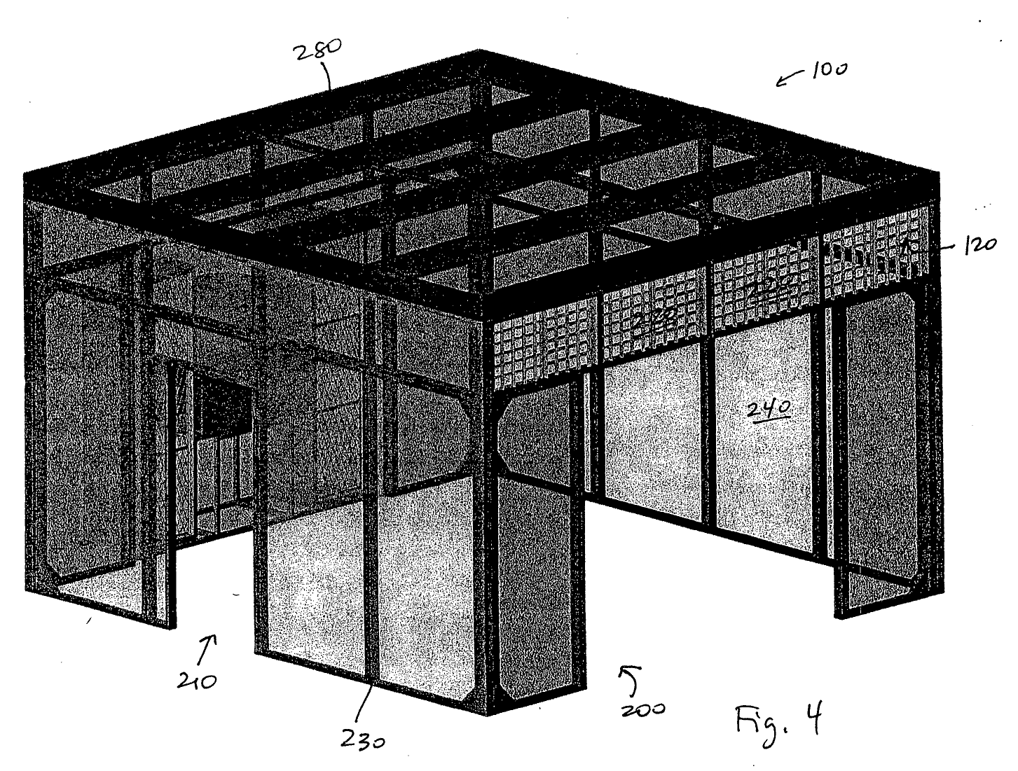

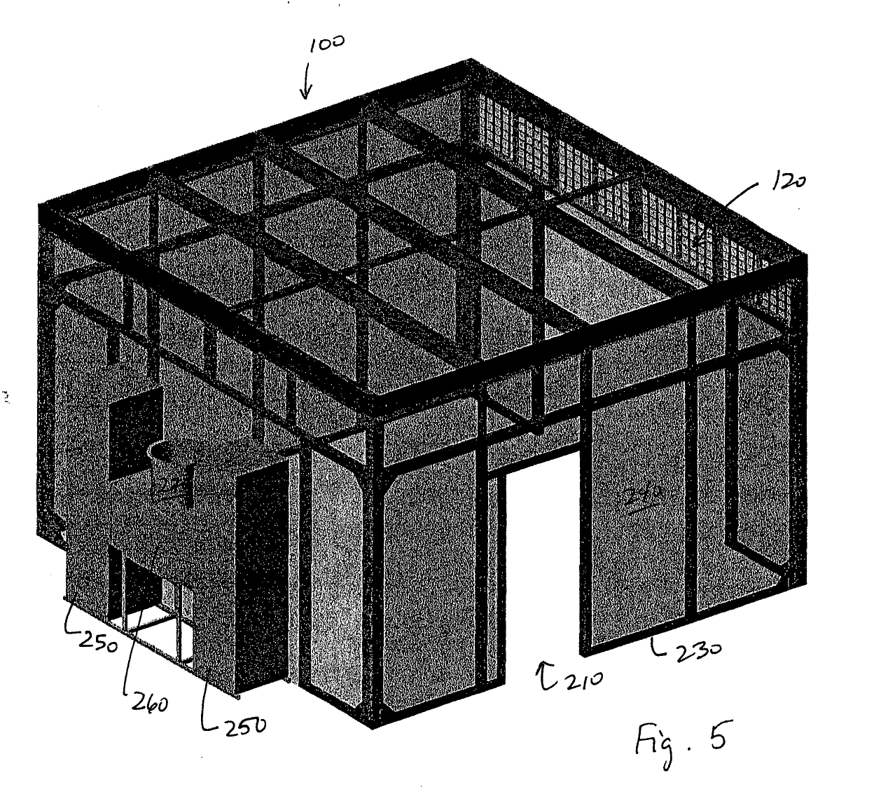

FIGS. 3, 4 and 5 show a preferred example of the enclosure, using wood (or metal) framing 230 to form panels which are joined together as the walls and ceiling 280 of the enclosure 100 (such as by bolting or otherwise fastening the modular panels together). Preferably, a protective film 240 is fastened to the framing which results in a protected workspace. The protective film may be a replaceable element, and can be, for example, any type of plastic sheeting. As an illustration, the applicant has found that common greenhouse plastic is suitable. One advantage of using an inexpensive replaceable protective film is that it can be torn down and disposed instead of cleaned, as the walls are exposed to overspray and general mess in the enclosure. Translucent plastic has been found particularly advantageous as it allows shop light (or daylight) into the enclosure without the need to wire the enclosure for special lighting.

Air is drawn into the enclosure through air inlet portion 120. As can be best seen in FIG. 3, the inlet is preferable covered with one or more louvered grilles 220. The louvers in the grilles are preferably individually adjustable to allow air to be “engineered” as it flows into and through the enclosure. Air is drawn through filter boxes 250 through plenum 260 by tube-axial fan 270. It has been found that a fan motor on the order of about 2 HP may be adequate for many coating applications. The air velocity can be kept to around 4000 cubic feet/minute, which is substantially lower than that required in most complex paint spray booth air systems (which may be 12000 cubic feet/minute or more).

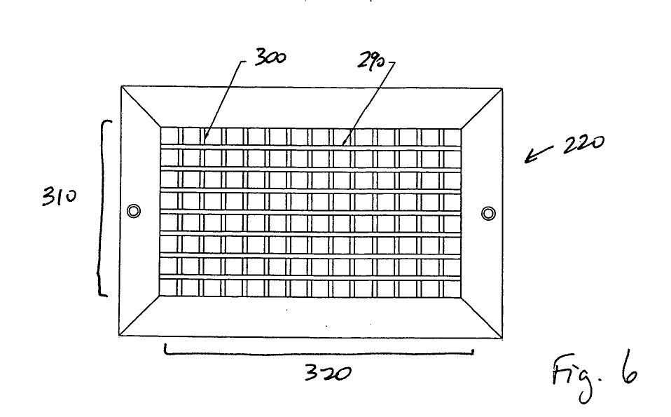

The grille itself is shown in FIG. 6. Louvers are provided in horizontal and vertical orientation. The louvers may be ganged to deflect as a vertical set 310, and horizontal set 320, or as is preferred in the present case, the louvers may be individually moveable as vertical louvers 300 or horizontal louvers 290. Preferably, each louver can be completely opened and shut, or deflected to any intermediate position on its axis. By shutting certain louvers completely, a higher air velocity may be achieved from lesser volume of incoming air. Also, by positioning the louvers carefully, air may be deflected into otherwise dead spaces (in corners, along the floor, or ceiling, in behind tall workpieces . . . ) to keep air flow lively. The louvers may be hand-repositionable or may be controlled by some other control means (e.g. a dial-type controller—not shown).

The foregoing is considered as illustrative only of the principles of the invention. Further, since numerous modifications and changes will readily occur to those skilled in the art, it is not desired to limit the invention to the exact processes, components and applications shown and described, and accordingly, all suitable modifications and equivalents may be resorted to, falling within the scope of the invention and the appended claims and their equivalents.

What is claimed is:

1. A spray enclosure for plural component coating application comprising:
a framework of four panel walls and a ceiling, the panel walls being cladded in a protective film to altogether enclose a protected workspace, at least one said wall having an opening for entry and exit of an operator and a workpiece to be coated;
a first said wall comprising an air inlet portion covered by at least one louvered grille with double-deflection louvers manipulable in at least two axes to deflect incoming air to the protected workspace;
a second said wall opposite the first wall and having an air filter, fan and exhaust assembly for filtering and drawing air through the protected workspace to an exhaust defined in the opposing wall;
wherein the spray enclosure is adapted for efficient laminar air flow through the protected workspace.

2. The spray enclosure according to claim 1, wherein the air inlet portion extends across the width of the first wall.

3. The spray enclosure according to claim 1, wherein the grille comprises a first set of louvers in a horizontal orientation relative to the first wall, and a second set of louvers in a vertical orientation relative to the first wall.

4. The spray enclosure according to claim 3, wherein each set of louvers is moveable between open and closed positions without mutual interference.

5. The spray enclosure according to claim 1, wherein each louver is independently movable between open and closed positions.

6. The spray enclosure according to claim 1, wherein the louvers of said grille are pre-set in an orientation to direct air into otherwise dead spots in the protected workspace.

7. The spray enclosure according to claim 1, wherein the enclosure is adapted for plural component spray by an operator and wherein the workpiece to be coated comprises a vehicle surface.

8. The spray enclosure according to claim 7, wherein the plural component is polyurethane coating.

9. The spray enclosure according to claim 7, wherein the vehicle surface is a truck bed.

10. The spray enclosure according to claim 1, wherein the opening is sized for entry and exit of a vehicle.

11. A kit for assembling a spray enclosure for plural component coating application comprising:
a plurality of framed wall panels fastenable into a four wall framework, at least one said wall having an opening for entry and exit of an operator and a workpiece to be coated;
a protective film for cladding the framework to altogether enclose a protected workspace;
at least one louvered grille with double-deflection louvers manipulable in at least two axes for installation into an air inlet portion of a first wall, the louvered grille being adapted for deflecting incoming air to the protected workspace;
an air filter, fan and exhaust assembly for installation into a second opposing wall for filtering and drawing air through the protected workspace to an exhaust defined in the opposing wall;
wherein the spray enclosure when assembled is adapted for efficient laminar air flow through the protected workspace.
